(19) United States
(12) Patent Application Publication
(10) Pub. No.: US 2026/0280363 A1
(43) Pub. Date: Sep. 17, 2026

(54) CORE, AXIAL GAP MOTOR, METHOD OF MANUFACTURING CORE, AND CORE MANUFACTURING APPARATUS

(71) Applicant: SUMITOMO ELECTRIC SINTERED ALLOY, LTD., Takahashi-shi (JP)

(72) Inventors: Masaaki EIDA, Takahashi-shi (JP); Tatsuya SAITO, Takahashi-shi (JP); Yuki HIRAO, Takahashi-shi (JP)

(73) Assignee: SUMITOMO ELECTRIC SINTERED ALLOY, LTD., Takahashi-shi (JP)

(21) Appl. No.: 19/565,604

(22) Filed: Mar. 13, 2026

(30) Foreign Application Priority Data
Mar. 17, 2025 (JP) 2025-042121

(51) Int. Cl. H02K 1/14; H02K 15/121

(52) U.S. Cl. CPC H02K 1/146; H02K 15/121; H02K 2213/03; H02K 2215/00

(57) ABSTRACT

A core is configured to be used for an axial gap motor. The core includes a yoke having an annular shape and a plurality of teeth each having a columnar shape and disposed around an axis of the yoke to be spaced from each other. The yoke and the plurality of teeth are integrally formed of a powder compact. The yoke has a first surface having a boundary with respect to the plurality of teeth, a second surface opposite to the first surface, and an outer circumferential surface and an inner circumferential surface connecting the first surface and the second surface to each other.

### CROSS-REFERENCE TO RELATED APPLICATION

This application claims priority based on Japanese Patent Application No. 2025-042121 filed on Mar. 17, 2025, and the entire contents of the Japanese patent application are incorporated herein by reference.

### TECHNICAL FIELD

The present disclosure relates to a core, an axial gap motor, a method of manufacturing a core, and a core manufacturing apparatus.

### BACKGROUND

Patent Literature (Japanese Unexamined Patent Application Publication No. 2021-100329) discloses a core used in an axial gap type rotating electrical machine. The core includes an annular yoke and a plurality of columnar teeth protruding from a surface of the yoke. The yoke and the plurality of teeth are integrally formed of a powder compact. A coil is disposed at each of the teeth.

### SUMMARY

A core according to the present disclosure is a core configured to be used for an axial gap motor, the core includes a yoke having an annular shape, and a plurality of teeth each having a columnar shape and disposed around an axis of the yoke to be spaced from each other. The yoke and the plurality of teeth are integrally formed of a powder compact. The yoke has a first surface having a boundary with respect to the plurality of teeth, a second surface opposite to the first surface, and an outer circumferential surface and an inner circumferential surface connecting the first surface and the second surface to each other. Each of the plurality of teeth has an outer region located, when the core is viewed in a first direction parallel to the axis, on an outer side with respect to a first envelope circle formed by the outer circumferential surface, and a first end surface located at a leading end of a portion projecting from the first surface in the first direction. Each of the outer regions has a second end surface opposite to the first end surface. The second end surface is arranged between an extension surface of the second surface and the first end surface to be spaced from the extension surface of the second surface. The second surface includes a knockout pin mark.

### BRIEF DESCRIPTION OF THE DRAWINGS

FIG. 1 is a schematic perspective view showing an example of a core of a first embodiment.

FIG. 2 is a schematic bottom plan view of the core of FIG. 1.

FIG. 3 is a cross-sectional view of FIG. 2 taken along line III-III.

FIG. 4 is a schematic perspective view of a die used to manufacture a core of a first embodiment.

FIG. 5 is a schematic perspective view of a lower punch used to manufacture a core of a first embodiment.

FIG. 6 is a schematic perspective view of an upper punch used to manufacture a core of a first embodiment.

FIG. 7 is a schematic cross-sectional view of a part of a state in which the die of FIG. 4, the lower punch of FIG. 5, and the upper punch of FIG. 6 are combined.

FIG. 8 is a schematic perspective view of an example of a stator including the core of FIG. 1.

FIG. 9 is a schematic cross-sectional view of an example of an axial gap motor including the stator of FIG. 8.

FIG. 10 is a schematic cross-sectional view of a knockout pin mark provided in a core of a second embodiment.

### DETAILED DESCRIPTION

It is desired to reduce the overall size of a stator that includes a coil disposed at each tooth of a core. In the core disclosed the Patent Literature, there is room for study regarding a wiring space for the coil.

An object of the present disclosure is to provide a core that can reduce a size of a stator and that is excellent in productivity. Another object of the present disclosure is to provide an axial gap motor including the core. Another object of the present disclosure is to provide a method of manufacturing a core that can easily manufacture a core capable of reducing a size of a stator. Another object of the present disclosure is to provide a core manufacturing apparatus that can easily manufacture a core capable of reducing a size of a stator.

A core of the present disclosure can reduce a size of a stator that includes a coil at each tooth of the core, and is excellent in productivity.

### Description of Embodiments of Present Disclosure

First, embodiments of the present disclosure will be listed and described.
(1) A core according to an aspect of the present disclosure is a core configured to be used for an axial gap motor, the core includes a yoke having an annular shape, and a plurality of teeth each having a columnar shape and disposed around an axis of the yoke to be spaced from each other. The yoke and the plurality of teeth are integrally formed of a powder compact. The yoke has a first surface having a boundary with respect to the plurality of teeth, a second surface opposite to the first surface, and an outer circumferential surface and an inner circumferential surface connecting the first surface and the second surface to each other. Each of the plurality of teeth has an outer region located, when the core is viewed in a first direction parallel to the axis, on an outer side with respect to a first envelope circle formed by the outer circumferential surface, and a first end surface located at a leading end of a portion projecting from the first surface in the first direction. Each of the outer regions has a second end surface opposite to the first end surface. The second end surface is arranged between an extension surface of the second surface and the first end surface to be spaced from the extension surface of the second surface. The second surface includes a knockout pin mark.

The axis of the yoke is a rotational symmetry axis of the yoke having the annular shape. That is, the axis of the yoke is a straight line that passes through the center of the circle of the annular shape and is perpendicular to both an extension surface of the first surface and an extension surface of the second surface of the yoke. In this specification, a direction parallel to the axis of the yoke is referred to as a first direction.

In the core of the above (1), when the core is viewed in the first direction, each of the teeth has the outer region located on the outer side with respect to the first envelope circle formed by the outer circumferential surface of the yoke. Since a space is provided between the second end surface of the outer region and the extension surface of the second surface of the yoke, a wiring space corresponding to the space is formed. In a core without the outer region, the wiring space for the coil is considered to be provided at a position overlapping the second surface of the yoke or a position overlapping the outer circumferential surface of the yoke. Regardless of the position at which the wiring space is provided, a stator having the coil disposed at each tooth of the core tends to be large as a whole. By forming the wiring space using the outer region, the stator that includes the coil at each tooth of the core is reduced in size as a whole.

The powder compact for forming the core is manufactured by filling a cavity formed by a die and a lower punch with powder and compressing the filled powder using an upper punch and the lower punch. Each of an inner circumferential surface of the die, an end surface of the upper punch, and an end surface of the lower punch has a shape corresponding to the core. When a step is formed between the second end surface and the extension surface of the second surface as in the core of the above (1), a protruding portion forming the step, the second end surface, and the second surface is provided in the upper punch. When extracting the powder compact from the die, usually, the die and the lower punch are relatively moved, and then the upper punch is raised. In the case where the protruding portion is provided in the upper punch, when the powder compact is released from the die, the powder compact engages with a step portion of the protruding portion due to springback. As described later, the upper punch is raised while pushing the powder compact by the knockout pin that moves independently with respect to the upper punch, so that the powder compact is less likely to engage with the step portion of the protruding portion. The knockout pin mark is formed on the second surface of the yoke. The core having the knockout pin mark on the second surface of the yoke is excellent in productivity because engaging of the powder compact into the upper punch is prevented in a manufacturing process of the core.

The powder is supplied to the cavity by a powder box having an opening in a bottom portion. The powder box linearly reciprocates above the die. When the powder box moves above the cavity, the powder in the powder box falls into the cavity from the opening of the powder box due to gravity. A peripheral edge portion forming the opening in the powder box drags some of the powder filled in the cavity with the reciprocating movement of the powder box. Thus, a region near a powder feed start point from the powder box in the cavity tends to be filled with more powder than a region near a powder feed turning back point. When a filling amount of the powder is uneven, a variation in length from the second surface of the yoke to the first end surface of each tooth may occur in the obtained powder compact. In the core of the above (1) including the outer region, an opening shape of the cavity is a shape obtained by combining the yoke and the outer region, and has a contour with protrusions and depressions. In the case of the opening having a contour with protrusions and depressions, a powder group disposed on an opening surface of the cavity has discontinuous portions around the axis of the yoke. When there are the discontinuous portions, the powder is less likely to be dragged by the powder box even when the powder box reciprocates. When the powder is less likely to be dragged during the reciprocating movement of the powder box, the filling amount of the powder in the cavity is less likely to be uneven. When the filling amount of the powder is less likely to be uneven, the variation in length from the second surface of the yoke to the first end surface of each tooth is less likely to occur in the obtained powder compact. Thus, in the core of the above (1), the variation in length from the second surface of the yoke to the first end surface of each tooth is small.

The length from the second surface of the yoke to the first end surface of each tooth may be longer in the region near the powder feed start point than in the region near the powder feed turning back point. Since the knockout pin mark is provided in at least one of the region near the powder feed start point or the region near the turning back point, it is possible to identify the tooth having the long length and the tooth having the short length. That is, the knockout pin mark can be used as a mark for the tooth having the long length or the tooth having the short length. When a double stator type axial gap motor is manufactured by combining two cores each formed of a powder compact, the two cores are arranged so that the tooth having the long length and the tooth having the short length face each other, and thus it is possible to reduce a variation in space between the teeth of the two cores facing each other.
(2) In the core according to the above (1), the knockout pin mark may include a plurality of knockout pin marks. The plurality of knockout pin marks may be provided around the axis to be spaced from each other.

In the manufacturing process of the core, the second surface of the yoke is pressed by the plurality of knockout pins provided around the axis of the yoke to be spaced from each other, so that a force can be applied to the second surface with reduced unevenness, and the core can be easily extracted from the die. When the force can be applied to the second surface with reduced unevenness, the core is less likely to be damaged. The core in which the plurality of knockout pin marks are provided around the axis of the yoke to be spaced from each other is less likely to be damaged in the manufacturing process of the core, and thus has excellent productivity.
(3) In the core according to the above (2), the plurality of knockout pin marks may include a first mark and a second mark. The first mark may be provided to be different in terms of at least one of shape and size from the second mark.

As described above, the length from the second surface of the yoke to the first end surface of each tooth may be longer in the region near the powder feed start point than in the region near the powder feed turning back point. When only one of the plurality of knockout pin marks is different from the others in terms of at least one of the shape and the size, the different knockout pin mark is easily used as a mark for the tooth having the long length or the tooth having the short length.
(4) In the core according to any one of the above (1) to (3), when viewed in the first direction, the knockout pin mark may be provided to overlap one of the plurality of teeth.

When viewed in the first direction, a position overlapping with one of the plurality of teeth is a position where the yoke and the tooth overlap with each other, and is a portion where a thickness in the core is thick. In the manufacturing process of the core, when the position overlapping with one of the plurality of teeth is pushed by the knockout pin when viewed in the first direction, the portion where the thickness in the core is thick is pushed, and thus the core is hardly deformed even when a force is applied from the knockout pin. When viewed in the first direction, the core in which the plurality of knockout pin marks are provided so that each one overlaps with any one of the plurality of teeth is less likely to be damaged in the manufacturing process of the core, and thus has excellent productivity.
(5) In the core according to any one of the above (1) to (4), the knockout pin mark may be a protruding portion protruding from the second surface in the first direction.

By forming a recessed portion in a case for the axial gap motor, the core can be positioned in the case by fitting the knockout pin mark into the recessed portion when the core is disposed in the case.
(6) In the core according to the above (5), the protruding portion may have a rounded leading end.

When the leading end of the protruding portion is rounded, the knockout pin mark formed as the protruding portion is easily fitted into the recessed portion formed in the case.
(7) In the core according to the above (5) or (6), a cross-sectional area of the protruding portion may be 0.7 mm² to 20 mm².

In the manufacturing process of the core, when the cross-sectional area of the knockout pin is within the above range, the core is easily pushed by the knockout pin, and the core is less likely to be damaged. The core including the knockout pin mark in which the cross-sectional area is formed as the protruding portion within the above range is less likely to be damaged in the manufacturing process of the core, and has excellent productivity.
(8) In the core according to any one of the above (1) to (4), the knockout pin mark may be a recessed portion opening on the second surface.

When the knockout pin mark is a recessed portion, the second surface of the yoke and an inner surface of the case are easily come into surface contact with each other when the core is disposed in the case for the axial gap motor. When the second surface of the yoke and the inner surface of the case are in surface contact with each other, heat is easily transferred from the yoke to the case, and heat dissipation of the axial gap motor is easily enhanced. By forming a protruding portion in the case, the core can be positioned in the case by fitting the protruding portion into the knockout pin mark when the core is disposed in the case for the axial gap motor.
(9) In the core according to the above (8), the recessed portion may have a rounded bottom surface.

When the bottom surface of the recessed portion is rounded, the protruding portion formed in the case is easily fitted into the knockout pin mark formed as the recessed portion.
(10) In the core according to the above (8) or (9), an opening area of the recessed portion may be 0.7 mm² to 20 mm².

In the manufacturing process of the core, when the cross-sectional area of the knockout pin is within the above range, the core is easily pushed by the knockout pin, and the core is less likely to be damaged. The core including the knockout pin mark in which the opening area of the recessed portion is within the above range is less likely to be damaged in the manufacturing process of the core, and has excellent productivity.
(11) An axial gap motor according to an aspect of the present disclosure includes a rotor, a stator facing the rotor in a direction along a rotation shaft of the rotor, and a case configured to accommodate the rotor and the stator. The stator includes the core according to any one of the above (1) to (10), and coils each disposed at a corresponding one of the plurality of teeth of the core.

The axial gap motor including the core is small.
(12) A method of manufacturing a core according to an aspect of the present disclosure includes forming a powder compact by compressing, in an inside of a die, powder by an upper punch and a lower punch, and extracting the powder compact from the inside of the die by relatively moving the die and the lower punch and raising the upper punch. The upper punch has a first end surface having an annular shape, and a plurality of projections on an outer circumferential surface of the upper punch, the plurality of projections being arranged around an axis of the first end surface to be spaced from each other. Each of the plurality of projections projects in a direction orthogonal to the axis and extends along the axis. A leading end of each of the plurality of projections includes a protruding portion protruding along the axis beyond the first end surface so that a step is formed between the protruding portion and the first end surface. In the extracting of the powder compact, the upper punch is raised while the powder compact is pushed by a knockout pin configured to move independently with respect to the upper punch.

With the method of manufacturing the core according to the above (12), it is possible to manufacture the core in which the outer region is provided in each of the plurality of teeth by the protruding portions provided in the upper punch. As described above, when extracting the powder compact from the die, usually, the die and the lower punch are relatively moved, and then the upper punch is raised. In the case where the protruding portion is provided in the upper punch, when the powder compact is released from the die, the powder compact engages with the step portion of the protruding portion due to springback. With the method of manufacturing the core according to the above (12), the upper punch is raised while the powder compact is pushed by the knockout pin that moves independently with respect to the upper punch, and thus the powder compact is less likely to engage with the step portion of the protruding portion. Thus, according to the method of manufacturing the core of the above (12), even when the upper punch is provided with the protruding portion for forming the outer region that forms the wiring space for the coil, engaging of the powder compact into the upper punch can be prevented, and productivity is excellent.
(13) A core manufacturing apparatus according to an aspect of the present disclosure includes a die having a cylindrical shape and through which a hole extends in a first direction, an upper punch and a lower punch configured to be fitted into the die, a knockout pin inserted into the upper punch in the first direction, and a drive mechanism configured to move the knockout pin in the first direction independently with respect to the upper punch. The upper punch has a first end surface having an annular shape, a through-hole extending in the first direction so that the through-hole is open in the first end surface, and a plurality of projections on an outer circumferential surface of the upper punch, the plurality of projections being arranged around an axis of the first end surface to be spaced from each other. Each of the plurality of projections projects in a direction orthogonal to the axis and extends along the axis. A leading end of each of the plurality of projections includes a protruding portion protruding along the axis beyond the first end surface so that a step is formed between the protruding portion and the first end surface. The knockout pin is disposed inside the through-hole so as to be slidable

In the core manufacturing apparatus according to the above (13), it is possible to manufacture the core in which the outer region is provided in each of the plurality of teeth by the protruding portion provided in the upper punch. In the core manufacturing apparatus of the above (13), the knockout pin moves independently with respect to the upper punch. Thus, when extracting the powder compact from the die, pushing of the powder compact by the knockout pin and rising of the upper punch can be independently controlled, and thus, the engaging of the powder compact into the upper punch can be prevented, and the shape of the knockout pin mark formed on the powder compact can be controlled.

### Details of Embodiments of Present Disclosure

Specific examples of a core, an axial gap motor, a method of manufacturing a core, and a core manufacturing apparatus of the present disclosure will be described with reference to the drawings. The same reference numerals in the drawings denote the same or corresponding parts. In the drawings, the configuration may be partially exaggerated or simplified for convenience of description. The size ratios of various portions in the drawings may be different from the actual ones. The present invention is not limited to these examples, but is defined by the scope of the claims, and is intended to include all modifications within the meaning and scope equivalent to the scope of the claims.

### First Embodiment

### (Core)

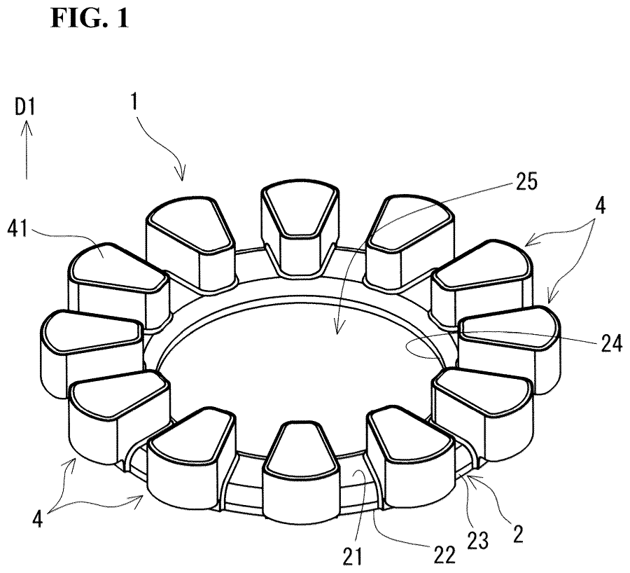

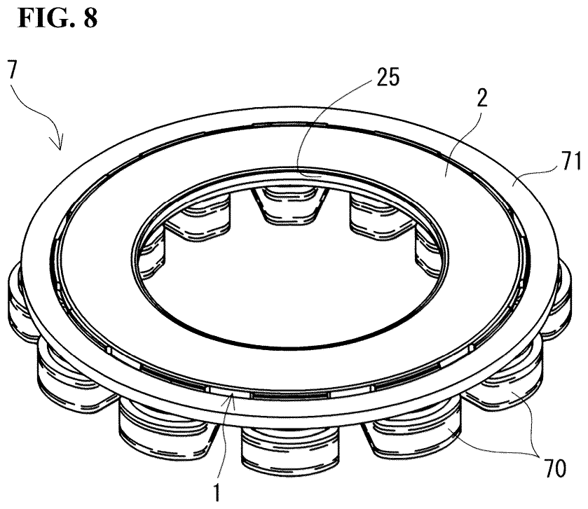

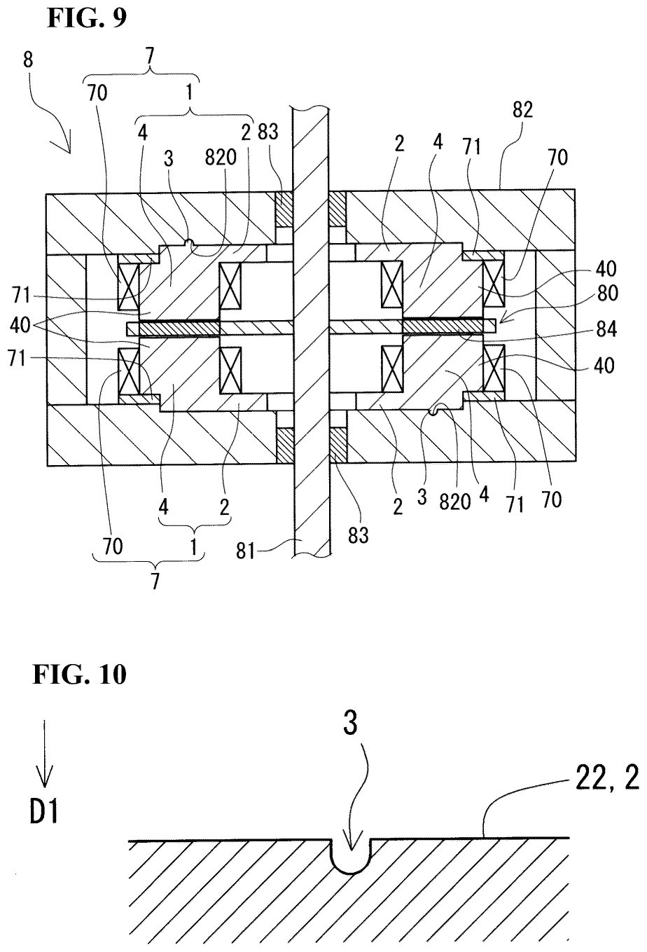

Referring to FIGS. 1 to 3 and, as needed, FIGS. 8 and 9, a core 1 of a first embodiment will be described. The core 1 is used in an axial gap motor 8 shown in FIG. 9. Typically, the core 1 is used as the core 1 of a stator 7 shown in FIG. 8.

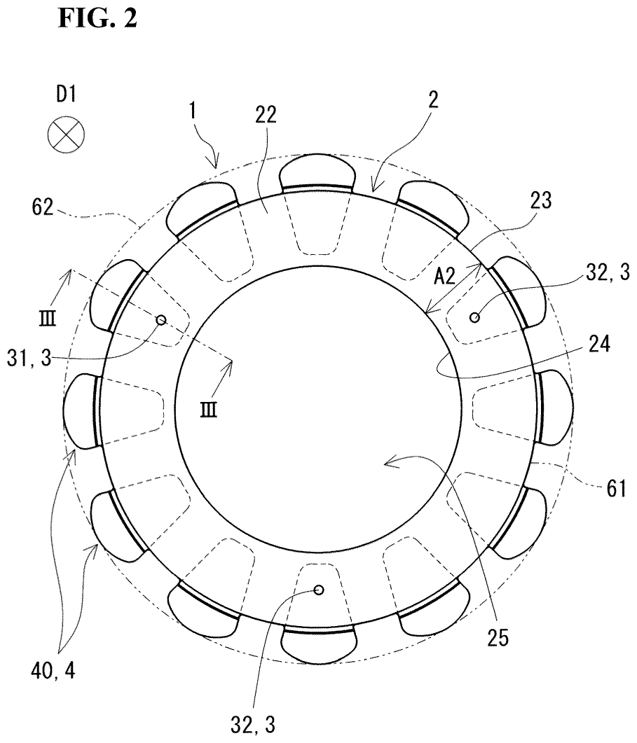

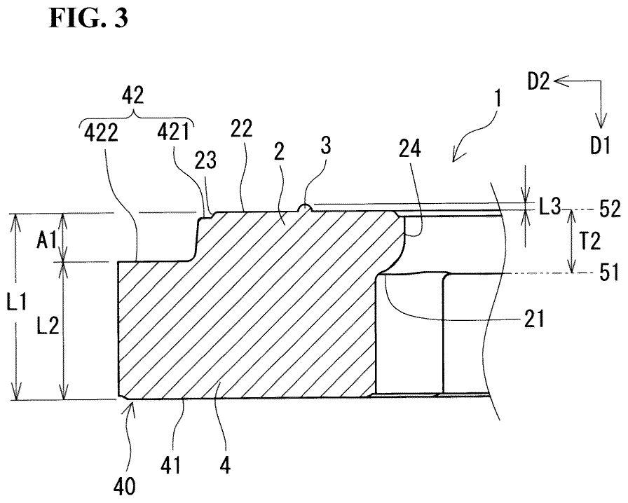

The core 1 includes a yoke 2 having an annular shape and a plurality of teeth 4 each having a columnar shape. The teeth 4 are disposed around an axis of the yoke 2 to be spaced from each other. The yoke 2 and the plurality of teeth 4 are integrally formed of a powder compact. One of the features of the core 1 of the first embodiment is that each of the teeth 4 includes an outer region 40. As shown in FIG. 2, the outer region 40 is, when the core 1 is viewed in a first direction D1, a region located on an outer side with respect to a first envelope circle 61 formed by an outer circumferential surface of the yoke 2. Another feature of the core 1 of the first embodiment is that a space A1 is provided between a second end surface 42 of the outer region 40 and a second extension surface 52 which is obtained by extending a second surface 22 of the yoke 2, as shown in FIG. 3. Another feature of the core 1 of the first embodiment is that the second surface 22 of the yoke 2 includes a knockout pin mark 3 as shown in FIGS. 2 and 3.

The first direction D1 is a direction parallel to the axis of the yoke 2. Hereinafter, the direction from bottom to top in FIG. 1 may be the first direction D1, or the direction from top to bottom in FIG. 1 may be the first direction D1. A direction orthogonal to the first direction D1 is referred to as a second direction D2. The second direction D2 is a direction from the center of the yoke 2 toward each of the teeth 4 along the diameter of the yoke 2 as shown in FIG. 3.

### ((Yoke))

As shown in FIGS. 1 and 2, the yoke 2 is a plate member having an annular shape in plan view. The yoke 2 includes a first surface 21, the second surface 22, an outer circumferential surface 23, and an inner circumferential surface 24. The first surface 21 is a surface having a boundary with respect to the plurality of teeth 4, and the plurality of teeth 4 project from the first surface 21 in the first direction D1. The second surface 22 is a surface opposite to the first surface 21. The first surface 21 and the second surface 22 are flat surfaces. An axial hole 25 extending from the first surface 21 to the second surface 22 is provided in a central portion of the yoke 2. The outer circumferential surface 23 and the inner circumferential surface 24 are surfaces connecting the first surface 21 and the second surface 22 to each other. The yoke 2 magnetically couples adjacent teeth 4 among the plurality of teeth 4 disposed around the axis of the yoke 2 to be spaced from each other.

As shown in FIG. 2, the yoke 2 is, when the core 1 is viewed in the first direction D1, a portion where the first envelope circle 61 formed by the outer circumferential surface 23 is a perfect circle. In other words, the yoke 2 is a portion where a space A2 between the outer circumferential surface 23 and the inner circumferential surface 24 is constant around the axis of the yoke 2. All portions of core 1 located outward from the first envelope circle 61 are part of the teeth 4 described later.

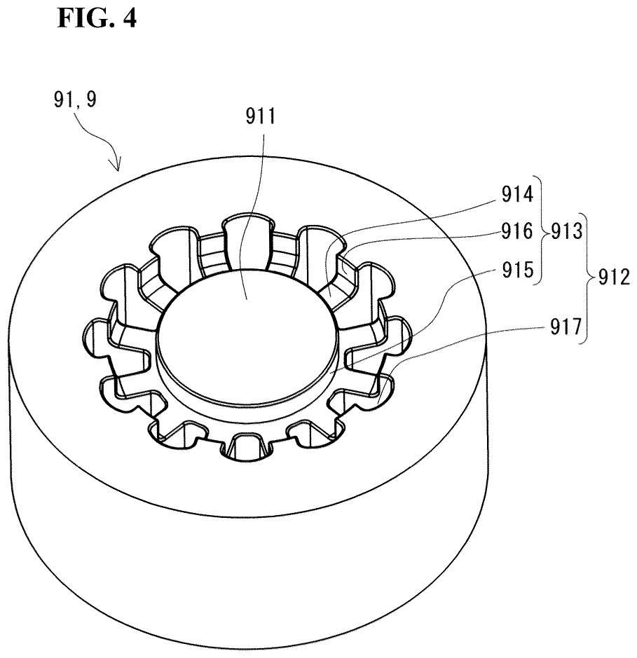

Each of a first corner formed by the first surface 21 and the outer circumferential surface 23 and a second corner formed by the first surface 21 and the inner circumferential surface 24 may be rounded. When the first corner is rounded, it is easy to reduce stress generated at a corner portion for forming the first corner in a die 91 shown in FIG. 4. When the second corner is rounded, it is easy to reduce stress generated at a corner portion for forming the second corner in the die 91. A radius of curvature of the first corner may be larger than a radius of curvature of the second corner. During pressure-compacting, a relatively large stress is generated at the corner portion for forming the first corner in the die 91. When the radius of curvature of the first corner is larger than the radius of curvature of the second corner, it is easy to reduce the stress generated at the corner portion for forming the first corner in the die 91. The radius of curvature of the first corner and the radius of curvature of the second corner may be the same. Only the first corner may be rounded. Neither the first corner nor the second corner may not be rounded.

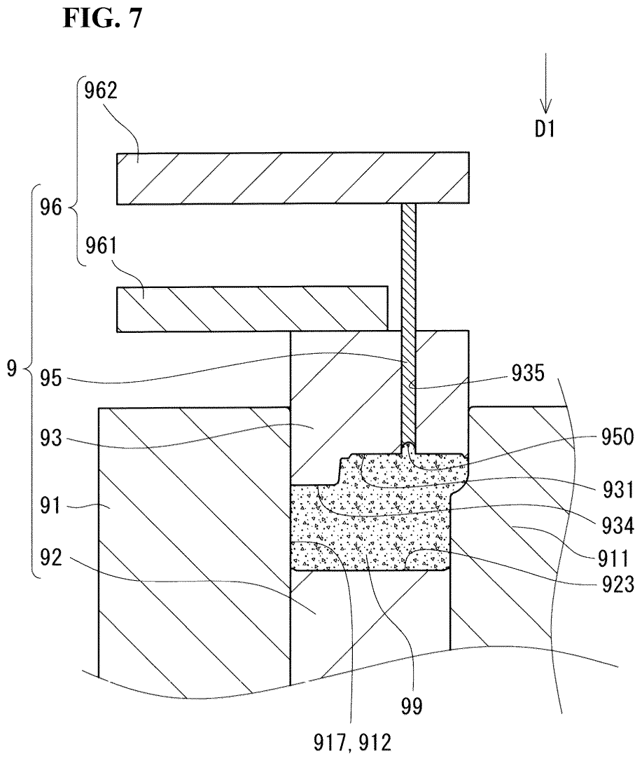

The second surface 22 includes the knockout pin mark 3 as shown in FIGS. 2 and 3. The knockout pin mark 3 is formed by transferring a shape of a leading end 950 of a knockout pin 95 shown in FIG. 7 in a manufacturing process of the core 1. As shown in FIG. 7, the core 1 is manufactured by filling a cavity formed by the die 91 and a lower punch 92 with a powder 99 and compressing the filled powder 99 by an upper punch 93 and the lower punch 92. The knockout pin 95 is provided to prevent the core 1 from engaging with the upper punch 93 when extracting the core 1 from the die 91, as described later. The core 1, which is provided with the knockout pin mark 3 on the second surface 22, prevents the core 1 from engaging with the upper punch 93 in the manufacturing process of the core 1, and thus has excellent productivity.

The number of knockout pin marks 3 is one or more. A plurality of knockout pin marks 3 are provided around the axis of the yoke 2 to be spaced from each other as shown in FIG. 2. Typically, the plurality of knockout pin marks 3 are provided at equal intervals around the axis of the yoke 2. In the present example, three knockout pin marks 3 are provided at intervals of 120° around the axis of the yoke 2. In the manufacturing process of the core 1, the second surface 22 is pushed by a plurality of knockout pins 95 provided around the axis of the yoke 2 to be spaced from each other, so that a force can be applied evenly to the second surface 22, and the core 1 can be easily extracted from the die 91. The core 1 is less likely to be damaged when force can be applied evenly to the second surface 22. The core 1, in which the plurality of knockout pin marks 3 are provided around the axis of the yoke 2 to be spaced from each other, is less likely to be damaged in the manufacturing process of the core 1, and thus has excellent productivity. The number of knockout pin marks 3 may be two, or may be four or more.

The plurality of knockout pin marks 3 are provided so that each one overlaps with any one of the plurality of teeth 4 when viewed in the first direction D1, for example. In FIG. 2, the contour of the region of each of the teeth 4 overlapping with the yoke 2 as viewed in the first direction D1 is indicated by a dashed line. When viewed in the first direction D1, positions overlapping with any of the plurality of teeth 4 are positions where the yoke 2 and the teeth 4 overlap with each other, and are portions where thicknesses in the core 1 are thick. In the manufacturing process of the core 1, when the positions overlapping with any of the plurality of teeth 4 are pushed by the knockout pins 95 when viewed in the first direction D1, the portions where the thicknesses in the core 1 are thick are pushed, and the core 1 is hardly deformed even when the forces are applied from the knockout pins 95. When viewed in the first direction D1, the core 1 in which the plurality of knockout pin marks 3 are provided so that each of the knockout pin marks 3 overlaps with any one of the plurality of teeth 4 is less likely to be damaged in the manufacturing process of the core 1, and thus has excellent productivity.

The knockout pin mark 3 of the present example is a protruding portion protruding from the second surface 22 in the first direction D1 as shown in FIG. 3. The knockout pin mark 3 formed as the protruding portion has a function of positioning with respect to a case 82 shown in FIG. 9. By forming a recessed portion 820 in the case 82, the core 1 is positioned with respect to the case 82 by fitting the knockout pin mark 3 formed as the protruding portion into the recessed portion 820. Since the case 82 is generally manufactured by cutting, it is easy to cut the recessed portion 820 during a manufacturing process of the case 82.

A leading end of the knockout pin mark 3 formed as the protruding portion is, for example, rounded. When the leading end of the knockout pin mark 3 is rounded, the knockout pin mark 3 formed as the protruding portion is easily fitted into the recessed portion 820. The leading end of the knockout pin mark 3 formed as the protruding portion may be a flat surface. When the leading end is a flat surface, a corner formed as a leading end surface and a side surface of the knockout pin mark 3 may be rounded. The knockout pin mark 3 of the present example has a hemispherical leading end surface.

In the present example, a cross-sectional shape of the knockout pin mark 3 is a perfect circle. The cross-sectional shape of the knockout pin mark 3 formed as the protruding portion is a shape obtained by cutting the knockout pin mark 3 in a direction orthogonal to the protruding direction thereof. The cross-sectional shape of the knockout pin mark 3 formed as the protruding portion may be a circular shape other than the perfect circle, for example, an elliptical shape. The cross-sectional shape of the knockout pin mark 3 formed as the protruding portion may be a polygon. The polygon is, for example, a quadrilateral. The polygon is not limited to a geometric polygon, and includes a shape in which at least one of a plurality of corners is rounded.

The cross-sectional area of the knockout pin mark 3 formed as the protruding portion is, for example, 0.7 mm² to 20 mm². The cross-sectional area of the knockout pin mark 3 is the cross-sectional area of the knockout pin mark 3 at the boundary portion with the second surface 22. In the manufacturing process of the core 1, when the cross-sectional area of the knockout pin 95 is within the above range, the core 1 is easily pushed by the knockout pin 95, and the core 1 is less likely to be damaged. The core 1 including the knockout pin mark 3 formed as the protruding portion having the cross-sectional area within the above range is less likely to be damaged in the manufacturing process of the core 1, and thus has excellent productivity. The cross-sectional area of the knockout pin mark 3 formed as the protruding portion may be 3 mm² to 13 mm², or 5 mm² to 10 mm².

A protruding length L3 of the knockout pin mark 3 formed as the protruding portion is, for example, 1 mm to 3 mm. When the protruding length L3 is 1 mm or more, the knockout pin mark 3 is easily fitted into the recessed portion 820 formed in the case 82. When the protruding length L3 is 3 mm or less, the strength of the knockout pin mark 3 formed as the protruding portion is high. The protruding length L3 may be 1.5 mm to 2.5 mm, or 1.75 mm to 2.25 mm.

The knockout pin mark 3 is provided, for example, in at least one of a region near a powder feed start point or a region near a turning back point. As described above, a first length L1 (FIG. 3) from the second surface 22 to a first end surface 41 of each tooth 4 may be longer in the region near the powder feed start point than in the region near the powder feed turning back point. Since the knockout pin mark 3 is provided in at least one of the region near the powder feed start point or the region near the turning back point, it is possible to identify the tooth 4 having the long first length L1 and the tooth 4 having the short first length L1. That is, the knockout pin mark 3 has a function of a mark for the tooth 4 having the long first length L1 or the tooth 4 having the short first length L1. When a double stator type axial gap motor 8 is manufactured by combining two cores 1 each formed of a powder compact, the two cores 1 are arranged so that the tooth 4 having the long first length L1 and the tooth 4 having the short first length L1 face each other, and thus it is possible to reduce a variation in space between the teeth 4 of the two cores 1 facing each other.

When the plurality of knockout pin marks 3 are provided, the plurality of knockout pin marks 3 include, for example, a first mark 31 and a second mark 32. In the present example, one first mark 31 and two second marks 32 are provided. The two second marks 32 have the same shape and size. The first mark 31 is provided to be different in terms of at least one of the shape and the size from the second mark 32. In the present example, an outer diameter of the first mark 31 is slightly larger than an outer diameter of the second mark 32. When only one of the plurality of knockout pin marks 3 is different in terms of at least one of the shape and the size from the others, the different knockout pin mark 3 is easily used as a mark for the tooth 4 having the long first length L1 or the tooth 4 having the short first length L1.

### ((Teeth))

Each of the plurality of teeth 4 is a member having a columnar shape as shown in FIG. 1. The plurality of teeth 4 are disposed around the axis of the yoke 2 to be spaced from each other. Typically, the plurality of teeth 4 are arranged at equal intervals around the axis of the yoke 2. The number of teeth 4 may be two or more, and can be selected as appropriate. The number of teeth 4 may be three or more, or six or more. When the core 1 is used in a three-phase AC rotating electrical machine, the number of teeth 4 is, for example, a multiple number of three. In the drawing, the core 1 including 12 teeth 4 is shown as an example.

### Basic Configuration of Teeth

Each of the teeth 4 has a main region that projects from the first surface 21 of the yoke 2 in the first direction D1. Each of the teeth 4 has a sub-region that projects toward an outer side from the main region in the second direction D2. “Toward an outer side” means a direction away from the axis of the yoke 2. As shown in FIG. 2, the sub-region is, when the core 1 is viewed in the first direction D1, the outer region 40 located on the outer side with respect to the first envelope circle 61. As shown in FIG. 3, the outer region 40 has a portion located between a first extension surface 51 extending from the first surface 21 and the second extension surface 52 extending from the second surface 22. In other words, the outer region 40 of the present example has a portion that projects toward an outer side from the outer circumferential surface 23 of the yoke 2.

Each of the teeth 4 has the first end surface 41 located at a leading end of a portion projecting from the first surface 21 in the first direction D1. The first end surface 41 of the present example is a surface parallel to the first surface 21. The first end surface 41 may be an inclined surface having a slight angle with respect to the first surface 21. A shape of the first end surface 41 is, for example, a trapezoidal shape. In the present example, a side of the trapezoidal first end surface 41 located distally from the axis of the yoke 2 is formed of a curved line. A region between the first end surface 41 and the first extension surface 51 in each tooth 4 has a uniform shape in the first direction D1. The tooth 4 having the trapezoidal first end surface 41 is a quadrangular prism. As the tooth 4 have the trapezoidal first end surface 41, the cross-sectional area of the tooth 4 can be easily increased. As the tooth 4 have the trapezoidal first end surface 41, a space between the adjacent teeth 4 can be easily increased. When a space between adjacent teeth 4 can be sufficiently large, the arrangement space of coils 70 shown in FIG. 8 can be easily increased, and it is possible to construct the stator 7 (FIG. 8, FIG. 9) having a high space factor. The shape of the first end surface 41 may be a triangular shape such as an isosceles triangle, a rectangular shape, or a circular shape. A region between the first end surface 41 and the first extension surface 51 in each tooth 4 may be configured to have a tapered shape from the first extension surface 51 toward the first end surface 41.

Here, the “trapezoidal shape” and the “triangular shape” include not only the geometric trapezoid and geometric triangle respectively, but also a shape substantially regarded as a trapezoid and a triangle respectively, while including a shape having rounded corners, as in the present example. For example, when the contour includes a straight line, the intersection of the extended line of the straight line includes a shape that forms a polygonal vertex. For example, when the contour includes a curve and a line, the contour includes a shape in which the intersection of the tangent of the curve with the line of an extension of the line forms a polygonal vertex.

Typically, the shape and size of each of the teeth 4 are the same.

### Outer Region

As shown in FIGS. 2 and 3, the outer region 40 includes the second end surface 42 that is a surface opposite to the first end surface 41. The second end surface 42 is a surface extending from the outer circumferential surface 23 of the yoke 2 in a direction intersecting the first direction D1. The second end surface 42 of the present example is along the second direction D2. As shown in FIG. 3, the second end surface 42 is arranged between the first end surface 41 and the second extension surface 52 to be spaced from the second extension surface 52 by the space A1. By having the space A1 between the second end surface 42 and the second extension surface 52, a wiring space for the coil 70 shown in FIG. 8 is formed in the core 1. The wiring space is formed in the core 1 by using the outer region 40, and thus the core 1 itself can support the wiring. Thus, the stator 7 (FIG. 8) that includes the coil 70 at each of the teeth 4 of the core 1 is reduced in size as a whole.

The space A1 is a space at a position farthest from the outer circumferential surface 23 among the spaces between the second end surface 42 and the second extension surface 52. The larger the space A1, the larger the wiring space. The space A1 is, for example, 10% or more of the first length L1 from the second surface 22 to the first end surface 41. The space A1 is correlated with a second length L2 of the outer region 40. The second length L2 is a length along the first direction D1 of a portion of the outer region 40 located most distally from the axis of the yoke 2. As the space A1 increases, the second length L2 decreases. In consideration of the second length L2, the space A1 is, for example, 40% or less of the first length L1. The space A1 is, for example, 10% to 40% of the first length L1. The space A1 may be 15% to 35%, or 20% to 30% of the first length L1.

The space A1 is smaller than a thickness T2 of the yoke 2. The thickness T2 is a distance between the first extension surface 51 and the second extension surface 52. Since the space A1 is smaller than the thickness T2, a magnetic flux flowing into the outer region 40 from a magnet 84 of a rotor 80 described later easily flows into the yoke 2 efficiently. The space A1 is, for example, 50% to 95% of the thickness T2. When the space A1 is 50% or more of the thickness T2, a wiring space in which a wiring is easily disposed can be formed. When the space A1 is 95% or less of the thickness T2, the magnetic flux flowing into the outer region 40 easily flows into the yoke 2. The space A1 may be 60% to 90%, or 70% to 80% of the thickness T2.

The second end surface 42 of the present example includes a proximal surface 421 and a distal surface 422. The proximal surface 421 is a surface located between the first extension surface 51 and the second extension surface 52 so as to be continuous with the second surface 22 or the outer circumferential surface 23 of the yoke 2. The proximal surface 421 of the present example is located in the vicinity of the second extension surface 52. The distal surface 422 is a surface that is located farther from the outer circumferential surface 23 in the second direction D2 than the proximal surface 421 and farther from the second extension surface 52 in the first direction D1 than the proximal surface 421. The distal surface 422 of the present example is located between the first extension surface 51 and the second extension surface 52 so as to be continuous with a side surface of the outer region 40. The second end surface 42 of the present example is largely composed of the distal surface 422. The space A1 is provided between the distal surface 422 and the second extension surface 52.

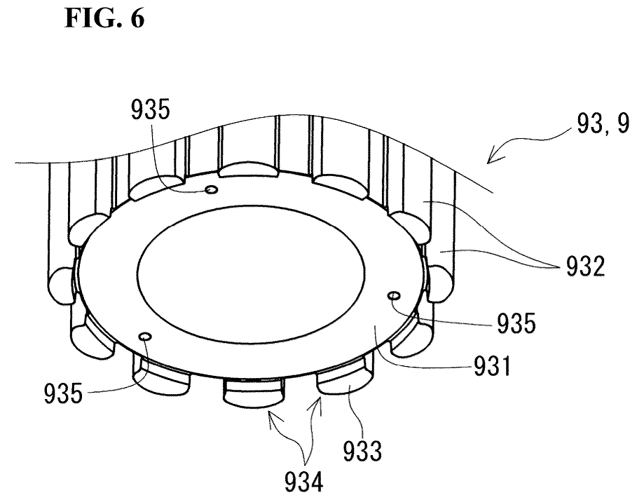

In the second end surface 42 of the present example, one step is composed of the proximal surface 421 and the distal surface 422. In the manufacturing process of the core 1, the yoke 2 is formed by the first surface 21 being supported by the die 91 (FIG. 4) and the second surface 22 being compressed by the upper punch 93 (FIG. 6). As shown in FIG. 7, each tooth 4 is formed by being compressed by the lower punch 92 and the upper punch 93. The second end surface 42 is formed by transferring a shape of a protruding portion 934 of the upper punch 93. When the upper punch 93 has the protruding portion 934, a relatively large stress is generated at a corner portion for forming the first corner of the yoke 2 in the die 91. By providing the step in the second end surface 42, the stress generated in the die 91 is easily reduced.

The second end surface 42 may be formed of a single surface. The second end surface 42 formed as a single surface may be an inclined surface that approaches the first end surface 41 as a distance from the axis of the yoke 2 with respect to the outer circumferential surface of the yoke 2 increases. When the second end surface 42 is an inclined surface, the upper punch 93 is easily removed from the powder compact after compression molding.

### Size of Outer Region

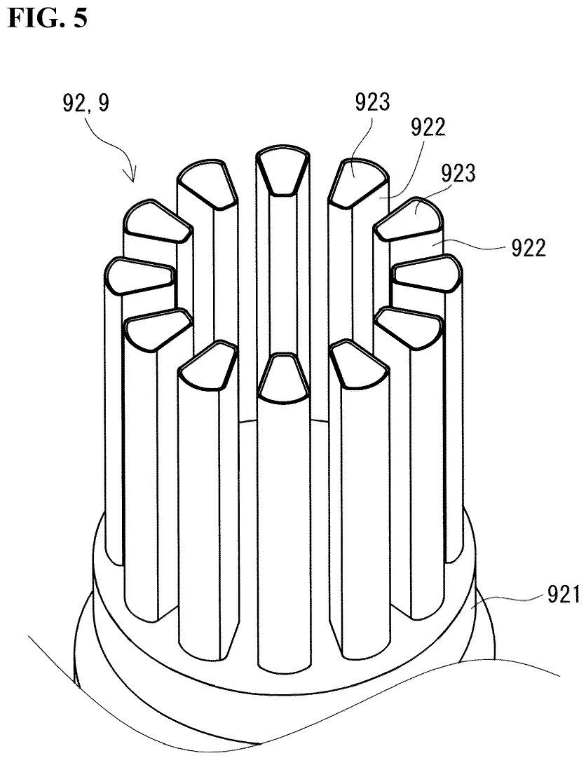

As shown in FIG. 2, when the core 1 is viewed in the first direction D1, a diameter of a second envelope circle 62 surrounding the plurality of teeth 4 is, for example, larger than a diameter of the first envelope circle 61 by 15% or more. The ratio of the diameter of the second envelope circle 62 to the diameter of the first envelope circle 61 is correlated with an amount of projection of the outer region 40 in the second direction D2 with respect to the outer circumferential surface 23 of the yoke 2. When the diameter of the second envelope circle 62 is larger than the diameter of the first envelope circle 61 by 15% or more, that is, when the ratio is 115% or more, a large wiring space is formed. When the ratio is 115% or more, an opening shape of the cavity formed by the die 91 (FIG. 4) and the lower punch 92 (FIG. 5) for manufacturing the core 1 has a contour with a large difference in unevenness in a direction along the diameter of the die 91. As the difference in the unevenness is larger, it is easier to reduce the variation in length from the second surface 22 of the yoke 2 to the first end surface 41 of each of the plurality of teeth 4. As the difference in the unevenness is larger, it is easier to reduce the stress generated at the corner portion for forming the first corner of the yoke 2 in the die 91.

When the ratio is too large, magnetic properties over the entire core 1 may become non-uniform. When the ratio is 130% or less, the core 1 is likely to have uniform magnetic properties over the entire core 1. The ratio may be 115% to 130%, 118% to 127%, or 120% to 125%.

As shown in FIG. 3, in each of the teeth 4, the ratio of the second length L2 to the first length L1 is, for example, 60% to 90%. As described above, the ratio of the second length L2 to the first length L1 is correlated with the space A1 between the second end surface 42 and the second extension surface 52. When the ratio is 90% or less, the wiring space corresponding to the space A1 is formed. When the ratio is 60% or more, the magnetic flux flowing into the outer region 40 from the magnet 84 of the rotor 80 to be described later easily flows into the yoke 2 efficiently. The ratio of the second length L2 to the first length L1 may be 65% to 85%, or 70% to 80%.

### ((Constituent Material))

The core 1 is formed of a powder compact containing soft magnetic powder. The soft magnetic powder includes iron-based particles made of pure iron or an iron-based alloy, for example. The pure iron means that the purity is 99% or more, that is, the content of iron (Fe) is 99% by mass or more. The pure iron has effect of high saturation magnetic flux density, excellent formability, and easy densification by pressure-compacting. Thus, when the material contains the iron-based particles made of pure iron, the material can be formed into the core 1 having a high saturation magnetic flux density, the core 1 having a high relative density and a high density, and the core 1 having improved manufacturability, which is easy to be formed in the manufacturing process. In addition, because the material is dense, the material can be formed into the core 1 having higher saturation magnetic flux density and having excellent mechanical property such as strength. The iron-based alloy contains an additive element, and the balance is Fe and inevitable impurities. The iron-based alloy includes one or more additive elements. The additive element is, for example, silicon (Si), aluminum (Al), or chromium (Cr). The electric resistance of the iron-based alloy is larger than that of pure iron. Thus, when the iron-based particles made of the iron-based alloy are contained, iron loss such as eddy current loss can be reduced, and the core 1 can be made to have low loss. When the iron-based particles made of the iron-based alloy are contained, relative magnetic permeability is easily increased. The core 1 may contain both iron-based particles made of pure iron and iron-based particles made of an iron-based alloy.

The soft magnetic powder generally includes coated particles each having an insulating coating on the surface of powder particle made of a soft magnetic material. When coated particles are included, iron loss such as eddy current loss can be reduced, resulting in the low loss core 1. In particular, when coated particles having powder particle made of pure iron and insulating coating are included, the core 1 having a high saturation magnetic flux density, enhanced magnetic properties, and a low loss can be obtained. The constituent material of the insulating coating is, for example, oxide such as phosphate, silica, magnesium oxide, or aluminum oxide.

### (Core Manufacturing Apparatus)

The above-described core 1 can be manufactured by using a manufacturing apparatus 9 shown in FIGS. 4 to 7. The manufacturing apparatus 9 includes the die 91 shown in FIG. 4, the lower punch 92 shown in FIG. 5, the upper punch 93 shown in FIG. 6, and the knockout pin 95 and a drive mechanism 96 shown in FIG. 7.

In the manufacturing apparatus 9, the core 1 shown in FIG. 1 is formed in an upside-down orientation as shown in FIG. 7. In the manufacturing apparatus 9, the first surface 21 of the core 1 is supported by the die 91, and the second surface 22 of the core 1 is compressed and formed by the upper punch 93. The first direction D1 shown in FIG. 7 is a direction common to the first direction D1 shown in FIG. 1. The first direction D1 in the manufacturing apparatus 9 is a direction parallel to an axis of the die 91. Both a direction from bottom to top and a direction from top to bottom in FIG. 7 are referred to as the first direction D1.

The die 91 is a member having a cylindrical column shape. As shown in FIG. 4, the die 91 includes a central portion 911 and an outer peripheral portion 912. The central portion 911 is a solid body that constitutes a central region including the axis of the die 91 and extends to both end surfaces of the die 91. The central portion 911 is for forming the axial hole 25 of the yoke 2 in the core 1. The outer peripheral portion 912 is located at an outer periphery of the central portion 911. The outer peripheral portion 912 includes a recessed portion 913 and a through-hole 917 which are open in an upper surface of the die 91. The recessed portions 913 and the through-holes 917 are alternately arranged around the axis of the die 91. The recessed portion 913 includes a bottom portion 914, an inside surface 915, and an outside surface 916. The inside surface 915 is also a side surface of the central portion 911. The outside surface 916 is provided to face the inside surface 915. The bottom portion 914 connects the inside surface 915 and the outside surface 916 to each other. The recessed portion 913 is for forming a large part of the yoke 2 in the core 1. The bottom portion 914 forms the first surface 21 of the yoke 2. The outside surface 916 forms the outer circumferential surface 23 of the yoke 2. The inside surface 915 forms the inner circumferential surface 24 of the yoke 2. The through-hole 917 extends through the die 91 from top to bottom. The through-hole 917 is for forming the tooth 4 of the core 1. The through-hole 917 has the same cross-sectional shape and size as the first end surface 41 of the tooth 4. An envelope circle surrounding the plurality of through-holes 917 is larger than an envelope circle surrounding the plurality of recessed portions 913. The envelope circle surrounding the plurality of recessed portions 913 is formed by the outside surface 916 of the recessed portions 913. A contour forming the outer peripheral portion 912 has protrusions and depressions in a direction along the diameter of the die 91. The recessed portion 913 and an outer periphery region of the through-hole 917 in the upper surface of the die 91 are flush with an upper surface of the central portion 911. The lower punch 92 is inserted into the through-hole 917.

The lower punch 92 includes a base portion 921 and a plurality of columnar portions 922, as shown in FIG. 5. The base portion 921 is a member having a cylindrical column shape. The plurality of columnar portions 922 are arranged around an axis of the base portion 921 to be spaced from each other. Each of the columnar portion 922 is inserted into the through-hole 917 of the die 91. An end surface 923 of each of the columnar portion 922 has the same shape and size as the first end surface 41 of the tooth 4. The end surface 923 forms the first end surface 41 of the tooth 4.

The upper punch 93 is a member having a cylindrical shape. As shown in FIG. 6, the upper punch 93 includes a first end surface 931 having an annular shape. The first end surface 931 forms the second surface 22 of the yoke 2. The upper punch 93 further includes a plurality of projections 932 arranged around an axis of the first end surface 931 to be spaced from each other on an outer circumferential surface of the upper punch 93. Each of the projections 932 projects in a direction orthogonal to the axis of the first end surface 931 and extends along the axis of the first end surface 931. A leading end of each of projections 932 includes the protruding portion 934 protruding along the axis beyond the first end surface 931 so that a step is formed between the protruding portion 934 and the first end surface 931. The protruding portion 934 includes a second end surface 933 forming the step between protruding portion 934 and the first end surface 931. The second end surface 933 forms the second end surface 42 of the outer region 40 of the tooth 4. The upper punch 93 has a through-hole 935. In the present example, the three through-holes 935 are provided at equal intervals around the axis of the first end surface 931. Each of the through-holes 935 extends in a direction parallel to the axis of the first end surface 931. As shown in FIG. 7, each through-hole 935 is a through-hole that reaches an upper surface of the upper punch 93 from the first end surface 931. The axis of the first end surface 931 and the axis of the die 91 are coaxial.

The knockout pin 95 is disposed inside the through-hole 935 formed in the upper punch 93 so as to be slidable, as shown in FIG. 7. The knockout pin 95 moves along the first direction D1. The leading end 950 of the knockout pin 95 comes into contact with the powder 99 when the powder 99 is compressed by the lower punch 92 and the upper punch 93. The leading end 950 of the knockout pin 95 forms the knockout pin mark 3 on the powder compact. In the present example, the leading end 950 of the knockout pin 95 is a hemispherical recessed portion. When the powder 99 is compressed, a part of the powder 99 enters the recessed portion of the leading end 950.

The drive mechanism 96 moves the knockout pin 95 in the first direction D1 independently with respect to the upper punch 93. As shown in FIG. 7, the drive mechanism 96 of the present example includes a first plate 961, a second plate 962, and a cylinder (not shown). The first plate 961 is connected to an upper end portion of the upper punch 93. The second plate 962 is connected to an upper end portion of the knockout pin 95. The first plate 961 and the second plate 962 are supported by guide posts (not shown) so as to be slidable. The first plate 961 and the second plate 962 are movable along the first direction D1 by cylinders independent of each other. When the first plate 961 is lowered along the first direction D1, the upper punch 93 is lowered along the first direction D1 in synchronization with the first plate 961. When the first plate 961 is raised along the first direction D1, the upper punch 93 is raised along the first direction D1 in synchronization with the first plate 961. When the second plate 962 is lowered along the first direction D1, the knockout pin 95 is lowered along the first direction D1 in synchronization with the second plate 962. When the second plate 962 is raised along the first direction D1, the knockout pin 95 is raised along the first direction D1 in synchronization with the second plate 962.

### (Method of Manufacturing Core)

The method of manufacturing the core 1 described above includes a step of forming a powder compact by compressing, in an inside of the die 91, the powder 99 by the upper punch 93 and the lower punch 92, and a step of extracting the powder compact from the inside of the die 91 by relatively moving the die 91 and the lower punch 92 and raising the upper punch 93.

### ((Step of Forming Powder Compact))

The columnar portions 922 of the lower punch 92 are inserted into the through-holes 917 of the die 91, thereby forming a cavity to be filled with the powder 99. The powder is supplied to the cavity by a powder box (not shown). The powder box has an opening in a bottom portion. The powder box linearly reciprocates above the die 91. When the powder box moves above the cavity, the powder in the powder box falls into the cavity from the opening of the powder box due to gravity. When the powder 99 is filled in the cavity, the powder box turns back. At the time of this turning back, a peripheral edge portion forming the opening in the powder box tends to drag some of the powder 99 filled in the cavity. In the present example, an opening shape of the cavity has protrusions and recesses in directions along the diameters of the die 91 corresponding to a contour of the outer peripheral portion 912 of the die 91. In the case of the opening having a contour with protrusions and depressions, a group of powders 99 disposed on an opening surface of the cavity has discontinuous portions around the axis of the die 91. When there are discontinuous portions, the powder 99 is less likely to be dragged by the powder box even when the powder box reciprocates. When the powder 99 is less likely to be dragged during the reciprocating movement of the powder box, an amount of the powder 99 filled in the cavity is less likely to be uneven.

After the cavity is filled with the powder 99, the powder 99 is compressed by the lower punch 92 and the upper punch 93 as shown in FIG. 7. At this time, the knockout pin 95 is disposed at a predetermined position. In the present example, the knockout pin 95 is disposed so that the leading end 950 has a slight space from an extension surface of the first end surface 931. In the present example, since the leading end 950 of the knockout pin 95 is a hemispherical recessed portion, a recessed portion having a hemispherical bottom surface with respect to the first end surface 931 is formed. The powder 99 also enters the recessed portion. When the powder 99 is compressed by the lower punch 92 and the upper punch 93, the shape of the protruding portion 934 provided in the upper punch 93 is transferred to the powder compact.

### ((Step of Extracting Powder Compact))

In the step of extracting the powder compact, usually, the die 91 and the lower punch 92 are relatively moved, and then the upper punch 93 is raised. At this time, the upper punch 93 is raised while the powder compact is pushed by the knockout pin 95 that moves independently with respect to the upper punch 93. In the present example, the upper punch 93 is raised by raising the first plate 961 while the powder compact is pushed by the knockout pin 95 by lowering the second plate 962. When the powder compact is detached from the upper punch 93, the second plate 962 is raised. In the case where the upper punch 93 is provided with the protruding portion 934, when the powder compact is released from the die 91, the powder compact engages with a step portion of the protruding portion 934 due to springback. By raising the upper punch 93 while the powder compact is pushed by the knockout pin 95, the powder compact is less likely to engage with the step portion of the protruding portion 934.

A mark corresponding to the leading end 950 of the knockout pin 95 is formed on the powder compact. This mark is the knockout pin mark 3 provided on the core 1 shown in FIGS. 2 and 3. Since the upper punch 93 and the knockout pin 95 move independently of each other, an accuracy of the protruding length L3 (FIG. 3) of the knockout pin mark 3 is improved.

### (Axial Gap Motor)

Referring to FIGS. 8 and 9, the axial gap motor 8 of the first embodiment will be described. The axial gap motor 8 includes the rotor 80 and the stator 7. The stator 7 shown in FIG. 8 faces the rotor 80 in a direction along a rotation shaft of the rotor 80. FIG. 9 is a cross-sectional view taken along a plane parallel to a rotation shaft 81 of the axial gap motor 8. FIG. 9 shows a single rotor, double stator type in which one rotor 80 is assembled so as to be sandwiched between two stators 7. In addition, the axial gap motor 8 may be configured to include one rotor 80 and one stator 7, or may be configured so that one stator 7 is assembled so as to be sandwiched between two rotors 80.

As shown in FIG. 8, the stator 7 includes the core 1 and the coils 70. Each of the coils 70 is disposed at a corresponding one of the plurality of teeth 4 in the core 1. The coil 70 includes a tubular portion formed by spirally winding a wire. The coil 70 in the present example is an edgewise winding coil that includes a rectangular coated wire as the wound wire and that has a square tube shape. As shown in FIGS. 3 and 8, a wire bundle 71 of the coil 70 is disposed in a space formed according to the space A1 between the second end surface 42 of the outer region 40 of each of the teeth 4 and the second extension surface 52.

As shown in FIG. 9, the stator 7 and the rotor 80 are accommodated in the case 82 having a cylindrical column internal space. The case 82 includes a cylindrical portion and two plate portions. The cylindrical portion surrounds an outer periphery of the stator 7 and the rotor 80. The two plate portions are circular plates disposed at both ends of the cylindrical portion. The stator 7 and the rotor 80 are accommodated in the case 82 so as to be sandwiched between the two plate portions.

The stator 7 is fixed to the case 82 by fitting a part of the yoke 2 of the core 1 into the plate portion of the case 82. Each plate portion is provided with the recessed portion 820 into which the knockout pin mark 3 provided on the yoke 2 is fitted. The knockout pin mark 3 is fitted into the recessed portion 820, whereby the stator 7 is positioned with respect to the case 82. The knockout pin mark 3 of the present example is provided in a region near the powder feed start point as described above. The first length L1 shown in FIG. 3 may be longer in the region near the powder feed start point than in the region near the powder feed turning back point. When the two stators 7 are fitted into respective plate portions, the knockout pin mark 3 provided in the region near the powder feed start point among the knockout pin marks 3 formed on the yoke 2 of each of the stators 7 is fitted into the predetermined recessed portion 820, so that the tooth 4 having the long first length L1 and the tooth 4 having the short first length L1 can face each other. By arranging the two stators 7 so that the tooth 4 having the long first length L1 and the tooth 4 having the short first length L1 face each other, it is possible to reduce a variation in space between the teeth 4 of the two stators 7 facing each other.

Each plate portion is provided with a through-hole in the center potion. A bearing 83 is provided in the through-hole, and the rotation shaft 81 is inserted into the bearing 83. A bearing (not shown) is also provided in the axial hole 25 of the yoke 2, and the rotation shaft 81 is inserted into the bearing. The rotation shaft 81 extends through the case 82.

The rotor 80 is a flat member including a plurality of magnets 84 and a rotor body that supports the magnets 84. Each magnet 84 has a flat plate shape having a planar shape corresponding to the shape of the first end surface 41 of the tooth 4, for example. The rotor body is an annular member that is supported by the rotation shaft 81 so as to be rotatable with respect to the case 82. The magnets 84 are provided at equal intervals around the axis of the rotor body. Each magnet 84 is magnetized in a direction along an axis of the rotation shaft 81. The magnets 84 adjacent to each other around the axis of the rotor body are magnetized in opposite directions. As the rotor body rotates, the magnet 84 also rotates with the rotor body.

The stator 7 is disposed so that the first end surface 41 of the tooth 4 faces the magnet 84 of the rotor 80. The coil 70 of the stator 7 is energized to generate a rotating magnetic field, and the rotor 80 rotates relative to the stator 7 due to an attractive or repulsive force caused by the rotating magnetic field. As the rotor 80 rotates, the first end surface 41 of the tooth 4 receives a magnetic flux from the rotating magnet 84.

### Second Embodiment

The knockout pin mark 3 may be a recessed portion opening on the second surface 22 of the yoke 2, as shown in FIG. 10. With the knockout pin mark 3 being a recessed portion, when the core 1 is disposed in the case 82 of the axial gap motor 8, the second surface 22 of the yoke 2 and an inner surface of the case 82 are likely to come into surface contact with each other. When the second surface 22 of the yoke 2 and the inner surface of the case 82 are in surface contact with each other, heat is easily transferred from the yoke 2 to the case 82, and heat dissipation of the axial gap motor 8 is easily enhanced. By forming a protruding portion in the case 82, when the core 1 is disposed in the case 82 of the axial gap motor 8, the core 1 can be positioned in the case 82 by fitting the protruding portion into the knockout pin mark 3.

A bottom surface of the knockout pin mark 3 formed as the recessed portion is, for example, rounded. When the bottom surface of the knockout pin mark 3 is rounded, the protruding portion formed in the case 82 is easily fitted into the knockout pin mark 3 formed as the recessed portion. The bottom surface of the knockout pin mark 3 formed as the recessed portion may be a flat surface. When the bottom surface is the flat surface, an edge of the opening of the knockout pin mark 3 may be rounded. When the bottom surface is the flat surface, a side surface of the recessed portion may be an inclined surface that tapers from the opening edge of the knockout pin mark 3 toward the bottom surface. An angle of the inclined surface is, for example, 0.5° or more, 5° or more, or 10° or more. The knockout pin mark 3 shown in FIG. 10 is a recessed portion having a hemispherical bottom surface.

An opening area of the knockout pin mark 3 formed as the recessed portion is, for example, 0.7 mm² to 20 mm². In the manufacturing process of the core 1, when the cross-sectional area of the knockout pin 95 is within the above range, the core 1 is easily pushed by the knockout pin 95, and the core 1 is less likely to be damaged. The core 1 including the knockout pin mark 3 in which the opening area of the recessed portion is within the above range is less likely to be damaged in the manufacturing process of the core 1, and is excellent in productivity. The opening area of the knockout pin mark 3 formed as the recessed portion may be 3 mm² to 13 mm², or 5 mm² to 10 mm².

A depth of the knockout pin mark 3 formed as the recessed portion is, for example, 1 mm to 5 mm. When the depth is 1 mm or more, the protruding portion formed in the case 82 is easily fitted into the knockout pin mark 3 formed as the recessed portion. When the depth is 5 mm or less, the knockout pin 95 is easily pulled out from the powder compact in the manufacturing process of the core 1. The depth of the knockout pin mark 3 formed as the recessed portion may be 1.5 mm to 4 mm, or 2 mm to 3 mm.

When forming the knockout pin mark 3 formed as the recessed portion, the leading end 950 of the knockout pin 95 shown in FIG. 7 does not have the recessed portion, and the powder 99 is compressed in a state in which the leading end 950 protrudes from the first end surface 931 of the upper punch 93. The depth of the recessed portion of the knockout pin mark 3 is determined by a protruding length of the leading end 950 from the first end surface 931. In the present example, as in the first embodiment, the upper punch 93 and the knockout pin 95 move independently of each other, and thus an accuracy of the depth of the knockout pin mark 3 is improved.

### Third Embodiment

Although not shown, the knockout pin mark 3 may be flush with the second surface 22 of the yoke 2. The term “flush” as used herein means that the knockout pin mark 3 is not a clear protruding portion or recessed portion, but a flat surface formed with protrusions and depressions of less than 0.1 mm. The knockout pin mark 3 flush with the second surface 22 is formed by a flat surface at the leading end 950 of the knockout pin 95 shown in FIG. 7. Even when the knockout pin mark 3 is flush with the second surface 22, the knockout pin mark 3 can be visually observed. When the knockout pin mark 3 is flush with the second surface 22, the second surface 22 of the yoke 2 and the inner surface of the case 82 are likely to come into surface contact with each other when the core 1 is disposed in the case 82 of the axial gap motor 8. When the second surface 22 of the yoke 2 and the inner surface of the case 82 are in surface contact with each other, heat is easily transferred from the yoke 2 to the case 82, and the heat dissipation of the axial gap motor 8 is easily enhanced.

What is claimed is:

1. A core configured to be used for an axial gap motor, the core comprising:
a yoke having an annular shape; and
a plurality of teeth each having a columnar shape and disposed around an axis of the yoke to be spaced from each other,
wherein the yoke and the plurality of teeth are integrally formed of a powder compact,
wherein the yoke has
a first surface having a boundary with respect to the plurality of teeth,
a second surface opposite to the first surface, and
an outer circumferential surface and an inner circumferential surface connecting the first surface and the second surface to each other,
wherein each of the plurality of teeth has
an outer region located, when the core is viewed in a first direction parallel to the axis, on an outer side with respect to a first envelope circle formed by the outer circumferential surface, and
a first end surface located at a leading end of a portion projecting from the first surface in the first direction,
wherein each of the outer regions has a second end surface opposite to the first end surface,
wherein the second end surface is arranged between an extension surface of the second surface and the first end surface to be spaced from the extension surface of the second surface, and
wherein the second surface includes a knockout pin mark.

2. The core according to claim 1,
wherein the knockout pin mark includes a plurality of knockout pin marks, and
wherein the plurality of knockout pin marks are provided around the axis to be spaced from each other.

3. The core according to claim 2,
wherein the plurality of knockout pin marks include a first mark and a second mark, and
wherein the first mark is provided to be different in terms of at least one of shape and size from the second mark.

4. The core according to claim 1,
wherein, when viewed in the first direction, the knockout pin mark is provided to overlap one of the plurality of teeth.

5. The core according to claim 1,
wherein the knockout pin mark is a protruding portion protruding from the second surface in the first direction.

6. The core according to claim 5,
wherein the protruding portion has a rounded leading end.

7. The core according to claim 5,
wherein a cross-sectional area of the protruding portion is 0.7 mm² to 20 mm².

8. The core according to claim 1,
wherein the knockout pin mark is a recessed portion opening on the second surface.

9. The core according to claim 8,
wherein the recessed portion has a rounded bottom surface.

10. The core according to claim 8,
wherein an opening area of the recessed portion is 0.7 mm² to 20 mm².

11. An axial gap motor comprising:
a rotor;
a stator facing the rotor in a direction along a rotation shaft of the rotor; and
a case configured to accommodate the rotor and the stator,
wherein the stator includes
the core according to claim 1, and
coils each disposed at a corresponding one of the plurality of teeth of the core.

12. A method of manufacturing a core, the method comprising:
forming a powder compact by compressing, in an inside of a die, powder by an upper punch and a lower punch; and
extracting the powder compact from the inside of the die by relatively moving the die and the lower punch and raising the upper punch,
wherein the upper punch has
a first end surface having an annular shape, and
a plurality of projections on an outer circumferential surface of the upper punch, the plurality of projections being arranged around an axis of the first end surface to be spaced from each other,
wherein each of the plurality of projections projects in a direction orthogonal to the axis and extends along the axis,
wherein a leading end of each of the plurality of projections includes a protruding portion protruding along the axis beyond the first end surface so that a step is formed between the protruding portion and the first end surface, and
wherein, in the extracting of the powder compact, the upper punch is raised while the powder compact is pushed by a knockout pin configured to move independently with respect to the upper punch.

13. A core manufacturing apparatus comprising:
a die having a cylindrical shape and through which a hole extends in a first direction;
an upper punch and a lower punch configured to be fitted into the die;
a knockout pin inserted into the upper punch in the first direction; and
a drive mechanism configured to move the knockout pin in the first direction independently with respect to the upper punch,
wherein the upper punch has
a first end surface having an annular shape,
a through-hole extending in the first direction so that the through-hole is open in the first end surface, and
a plurality of projections on an outer circumferential surface of the upper punch, the plurality of projections being arranged around an axis of the first end surface to be spaced from each other,
wherein each of the plurality of projections projects in a direction orthogonal to the axis and extends along the axis,
wherein a leading end of each of the plurality of projections includes a protruding portion protruding along the axis beyond the first end surface so that a step is formed between the protruding portion and the first end surface, and
wherein the knockout pin is disposed inside the through-hole so as to be slidable.
